(19) United States
(12) Patent Application Publication
(10) Pub. No.: US 2005/0156419 A1
(43) Pub. Date: Jul. 21, 2005

(54) Device for actuating a vehicle safety system

(75) Inventors: Michael Gabler, Muhldorf (DE); Sebastian Bierwirth, Rechtmehring (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Airbag Systems GmbH

(21) Appl. No.: 11/028,689

(22) Filed: Jan. 4, 2005

(30) Foreign Application Priority Data
Jan. 20, 2004 (DE) 20 2004 000 801.7

(51) Int. Cl. B60R 21/28

(52) U.S. Cl. 280/740

(57) ABSTRACT

A device for actuating a vehicle safety system comprises a gas generator (12) having an outer housing (14) and a rigid gas deflection part provided outside the outer housing (14). The device further includes at least one elastic fastening means (18) for the gas deflection part, which presses the gas deflection part, when the gas generator (12) is not actuated, against the latter and with the escaping of gas varies the distance of the gas deflection part from the outer housing (14) depending on the gas pressure. The deflection part can be an integral portion of the fastening means (18).

### TECHNICAL FIELD

The invention relates to a device for actuating a vehicle safety system, in particular an inflation device for a gas bag.

### BACKGROUND OF THE INVENTION

Such a device is known from DE 196 26 463 A1. The gas generator has a metal band looped around its outside, which is deformed plastically by the gas flow and exposes flow paths for the gas in the direction towards the gas bag. The flow direction of the gas emerging from the gas generator is influenced by the metal sheet, in particular a direct flow of gas against the gas bag wall is avoided.

It is an object of the invention to influence the outflow behavior of the gas dependent on temperature.

### BRIEF SUMMARY OF THE INVENTION

A device for actuating a vehicle safety system comprises a gas generator having an outer housing and a rigid gas deflection part provided outside the outer housing. The device further includes at least one elastic fastening means for the gas deflection part, which presses the gas deflection part, when the gas generator is not actuated, against said gas generator and upon outflow of gas varies the distance of the gas deflection part from the outer housing depending on the gas pressure.

In the device proposed, the operation is not carried out with the pure plastic deformation of the gas deflection part; rather, an elastic fastening means is provided, by which different distances of the gas deflection part from the outer housing are obtained through the gas pressure, which continues to be elastic even after the maximum stress has been applied onto it, and brings about a returning of the gas deflection part. If, for example, the gas pressure becomes less at the end of the outflow process, then the elastic fastening means again reduces the distance between the outer housing and the gas deflection part, so that the outflow opening arising between these two parts becomes smaller again. The curve of the gas pressure (known as the outflow behavior) is, as is known, dependent on temperature. Through the elastic fastening means, the counter-pressure applied by the gas deflection part is varied, so that the burning rate of the pyrotechnic charge contained in the gas generator changes.

An advantage of the elastic fastening means also consists in that it has various elastic constants as a function of the temperature. At low temperatures it is harder, which is desirable with regard to the output characteristic, because it exposes the outflow openings in the outer housing of the gas generator at a later point in time. At higher temperatures the elastic fastening means is softer and exposes the openings more quickly.

The gas deflection part is preferably a baffle plate which is constructed for example in a trough shape and lies against the covering surface of the usually cylindrical gas generator.

When the gas generator is not actuated, an embodiment makes provision that the gas deflection part is pressed against the outer housing and, for example, closes the outflow openings in the outer housing. Theoretically it would, of course, also be possible to keep the gas deflection part a gap away from the outflow openings when the gas generator is not actuated.

The fastening means is preferably made of elastomeric material, for example in the form of one or more bands or tubes. The fastening means can, of course, be fastened on any parts of the device, but it is preferably fastened on the gas generator, so that the gas deflection part and the fastening means together with the gas generator form a self-contained pre-assembled unit.

In order to simplify the arresting of the fastening means on the gas deflection part and/or on the gas generator, it is guided around the deflection part or around the gas generator according to one embodiment. In the preferred embodiment it is guided around both, by the fastening means being constructed as a closed, ring-shaped body, which also improves its stability.

Another embodiment of the invention makes provision that, instead of the rigid gas deflection part defining a separate part, it is an integral portion of the elastic fastening means. In this case, the gas deflection part has a heat-resistant coating applied on an inner side directed towards the gas generator. Thereby, the gas deflection part is no longer rigid; it rather is elastic. In this embodiment, one component can be saved.

### BRIEF DESCRIPTION OF THE DRAWINGS

FIG. 1 shows a perspective view of a first embodiment of the device according to the invention when the gas generator is not actuated,

FIG. 2 shows the device according to FIG. 1 when the gas generator is actuated, and

FIG. 3 shows a perspective view of a second embodiment of the device according to the invention when the gas generator is actuated.

### BRIEF DESCRIPTION OF THE PREFERRED EMBODIMENTS

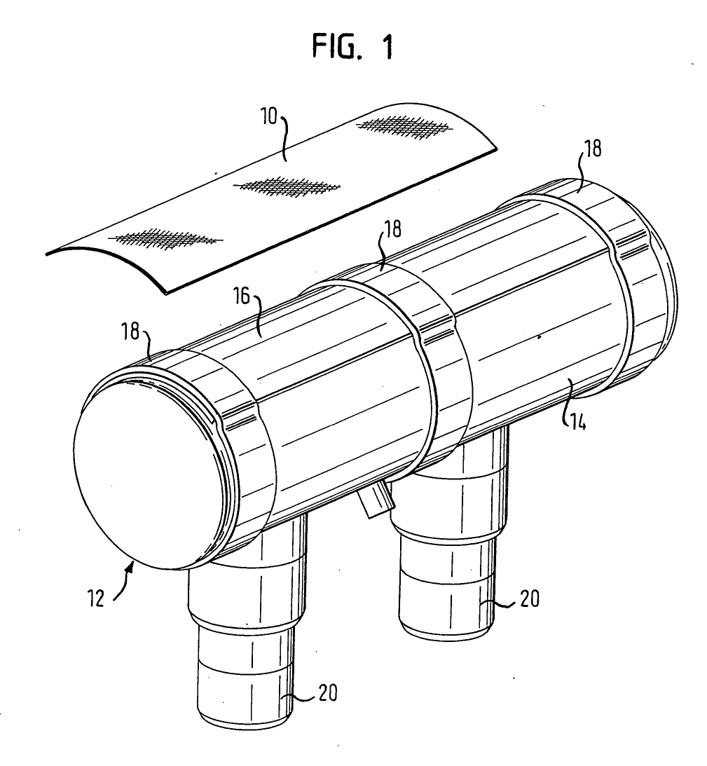

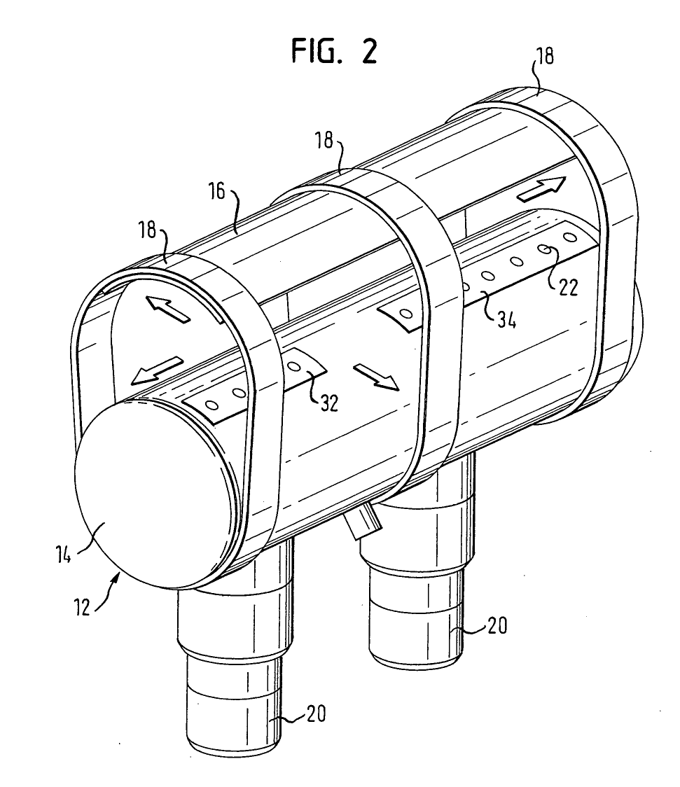

In FIG. 1 there is illustrated a device for actuating a vehicle occupant restraint system in the form of a gas bag 10. The gas bag is only drawn partially and surrounds the device for its actuation, which consists of a gas generator 12 with a tubular, elongated outer housing 14, a trough-shaped gas deflection part (baffle plate 16) lying against the covering surface of the outer housing 14 in the non-actuated state, and three elastic fastening means 18. The elastic fastening means 18 are closed rings made of an elastomeric material, which are guided around the baffle plate 16 and the outer housing 14 and press the baffle plate 16 against the outer housing, in order to close the radial outflow openings 22 (see FIG. 2) in the covering surface when the gas bag is not actuated.

Reference 20 designates two igniter units in which a pyrotechnic material is contained. The gas generated in the igniter units 20 flows into the interior of the outer housing 14, in order to mix there either with cold gas which is housed in a pressure chamber, or to ignite a further pyrotechnic charge inside the outer housing 14.

When gas leaves the outer housing 14 via the outflow openings 22, it flows against the baffle plate 16 and pushes the latter contrary to the force of the fastening means 18 away from the outer housing 14 (see FIG. 2). The distance between the outer housing 14 and the baffle plate 16 is dependent on the pressure of the outflowing gas. If the gas pressure decreases again, the baffle plate 16 is drawn closer to the outer housing 14 again.

At lower temperatures (operating range up to −40 degrees C. to +85 degrees C.) the elastomer of the fastening means 18 is harder, so that the outflow openings 22 are kept closed for a longer period and a higher gas pressure can build up in the outer housing 14 first.

The outflowing gas flows, as stated, firstly against the baffle plate 16 and can only subsequently flow against the outer wall of the gas bag 10, so that entrained particles have cooled down until they strike onto the gas bag wall.

In the embodiment illustrated in FIGS. 1 and 2 the gas flows out of the device via axial and radial slits between outer housing 14 and baffle plate 16 (see arrows).

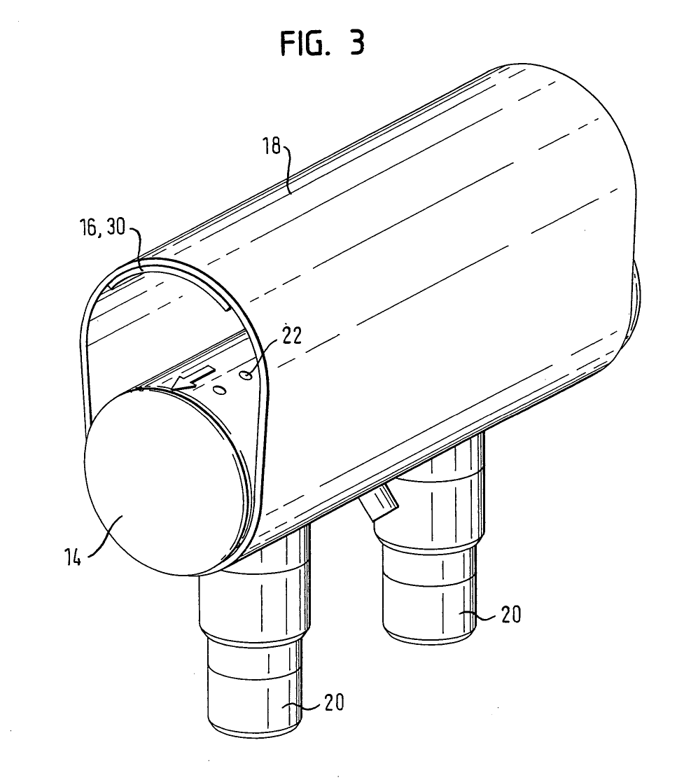

In the embodiment according to FIG. 3, instead of three fastening means only one tubular, elastomer fastening means 18 is provided. The latter is likewise closed in peripheral direction and is provided in one piece; it only has small openings for the passage of the igniter units 20. In the interior, the trough-shaped baffle plate 16 is arranged; here too, this baffle plate is pressed against the outer housing 14 of the gas generator and closes the outflow openings 22 when the gas generator is in the non-activated state.

On activation of the gas bag, there will arise only axial outflow slits from the device, because the fastening means 18 acts like a channel wall between baffle plate 16 and outer housing 14.

In both embodiments the baffle plate 16 is arrested against displacement for example by gluing, clamping or flanging on the fastening means 18.

Instead of the baffle plate 16 shown in FIG. 3, the fastening means 18 can also have a heat-resistant coating 30 in this region, i.e. on its inner side, by which the fastening means 18, however, maintains its elasticity in this region. The coated portion of the fastening means 30 defines the trough-shaped gas deflection part.

Alternatively, an insulation such as a thin foil could be provided on the outer side of the outer housing 14 at least in the region of the outflow openings 22, e.g. could be glued on. This insulation is designated by reference numbers 32, 34 in FIG. 2. The insulation 32, 34 is intended to protect against the entry of moisture into the gas generator 12. Due to the fact that it lies under the baffle plate 16 in the transportation state, the insulation 32, 34 is protected from damage. Preferably an individual insulation 32, 34 is to be provided for each of the two stages defined by the igniter units 20.

1. A device for actuating a vehicle safety system, said device comprising
a gas generator (12) having an outer housing (14),
a rigid gas deflection part provided outside said outer housing (14) and
at least one elastic fastening means (18) for said gas deflection part, which presses said gas deflection part, when said gas generator (12) is not actuated, against said gas generator (12) and, upon outflow of gas, varies a distance of said gas deflection part from said outer housing (14) depending on a gas pressure.

2. The device according to claim 1, wherein said gas deflection part is a baffle plate (16).

3. The device according to claim 1, wherein said gas deflection part is constructed in a trough shape.

4. The device according to claim 1, wherein said gas deflection part is pressed against said outer housing when said gas generator (12) is not actuated.

5. The device according to claim 1, wherein outflow openings (22) are provided in said outer housing (14), said gas deflection part closing said outflow openings when said gas generator is not actuated.

6. The device according to claim 1, wherein said fastening means (18) is made of an elastomeric material.

7. The device according to claim 1, wherein said fastening means (18) is fastened to said gas generator (12).

8. The device according to claim 1, wherein said fastening means (18) is guided around at least one of said gas deflection part and said gas generator (12).

9. The device according to claim 1, wherein said fastening means (18) is one of an elastomeric band and an elastomeric tube.

10. A device for actuating a vehicle safety system, said device comprising
a gas generator (12) having an outer housing (14),
at least one elastic fastening means (18) having a portion forming a gas deflection part provided outside said outer housing (14), which presses its gas deflection part, when said gas generator (12) is not actuated, against the gas generator, wherein upon outflow of gas, said deflection part being pushed away from said gas generator to vary a distance of said gas deflection part from said outer housing (14) depending on a gas pressure.

11. The device according to claim 10, wherein gas deflection part of said elastic fastening means (18) has a heat-resistant coating (30) applied on an inner side directed towards said gas generator.

12. The device according to claim 10, wherein said gas deflection part defines a baffle plate.

13. The device according to claim 10, wherein said gas deflection part is constructed in a trough shape.

14. The device according to claim 10, wherein said gas deflection part is pressed against said outer housing when said gas generator (12) is not actuated.

15. The device according to claim 14, wherein outflow openings (22) are provided in said outer housing (14), said gas deflection part closing said outflow openings when said gas generator is not actuated.
